(19) United States
(12) Patent Application Publication
(10) Pub. No.: US 2004/0233881 A1
(43) Pub. Date: Nov. 25, 2004

(54) Route discovery device and method in a mobile ad-hoc network

(75) Inventors: Hyun-Jeong Kang, Seoul (KR); Sung-Jin Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/840,177

(22) Filed: May 6, 2004

(30) Foreign Application Priority Data
May 6, 2003 (KR) 2003-28666

(51) Int. Cl. H04J 3/22

(52) U.S. Cl. 370/338

(57) ABSTRACT

A route discovery device and method in a mobile ad-hoc network. The route discovery device and method seamlessly maintain a route for providing service by establishing the service route while taking into account the efficiency of energy of a terminal in the mobile ad-hoc network. A mobile host broadcasts a service request message. One of relay hosts of the mobile hosts selects a service request message, calculates power information of the mobile host, includes the calculated power information of the mobile host in the power information included in the selected service request message and re-broadcast the service request message. A destination host of the mobile hosts selects a service request message, generates a service response message and transmits the service response message along a route of the selected message.

### PRIORITY

This application claims priority to an application entitled “ROUTE DISCOVERY DEVICE AND METHOD IN MOBILE AD-HOC NETWORK”, filed in the Korean Intellectual Property Office on May 6, 2003 and assigned Serial No. 2003-28666, the contents of which are hereby incorporated by reference.

### BACKGROUND OF THE INVENTION

1. Field of the Invention

The present invention relates generally to a route discovery device and method, and more particularly to a device and method for performing a route discovery operation in a mobile ad-hoc network.

2. Description of the Related Art

Conventionally, route discovery in a predetermined network is a process for determining a preferred path when a signal or data is transmitted from a source node to a destination node. Because all nodes in a wired network have stability but do not have mobility, a route setup operation is performed only one time or in a unit of a specific long period. A communication system with a wired network can transmit a signal or data when a route setup operation has been performed in all networks such as a backbone network, private networks, etc.

An increased number of private networks are currently present. A typical private network is a LAN (Local Area Network). The LAN performs communication through TCP/EP (Transmission Control Protocol/Internet Protocol). A commonly used physical transfer layer mainly employs the Ethernet. Companies currently using the Internet/Intranet developing from the LAN process many tasks through various types of communication networks for coupling the LAN to an external network.

A typical example of a wireless network is a cellular mobile communication system for performing mobile telephone communication and mobile data communication. As the wireless network, wireless communication systems, such as wireless LANs, MANs (Metropolitan Area Networks), and WANs (Wide Area Networks) are taken into account. One of the wireless LANs is a mobile ad-hoc network. The mobile ad-hoc network does not perform centralized management, and is a system for temporarily configuring a network without a fixed network basis.

A wireless mobile ad-hoc network will be described in detail herein below. Mobile communication terminals included in the mobile ad-hoc network are capable of conveniently exchanging data with other devices using radio-channel broadcast properties at anytime and anywhere.

The mobile ad-hoc network can rapidly configure a communication environment using the broadcast properties in a disaster state, war state, conference, personal network, or home network, even though no backbone communication structure is present. That is, the mobile ad-hoc network is not equipped with a special controller as in a fixed host performing a central management operation. Accordingly, the mobile communication terminals making up the mobile ad-hoc network perform a router function for routing information while serving as hosts. As the terminals having mobility perform the router function, a route can be varied anytime, because the mobile ad-hoc network can dynamically join and disjoin a network configured in advance due to the mobility of the terminals. As described above, because the mobile ad-hoc network has properties different from a pre-existing wired network, a different protocol or service search method for the mobile ad-hoc network from a routing protocol or service search method used in the pre-existing wired network is required.

A typical routing protocol, which is designed by taking into account dynamic topology variation or mobility of a mobile communication terminal in the mobile ad-hoc network, is an AODV (Ad-hoc On-Demand Distance Vector) routing protocol or an ODMRP (On-Demand Multicast Routing Protocol).

The AODV routing protocol or ODMRP is a protocol for determining a route in a state in which each host establishes a data route in advance. That is, the AODV routing protocol or ODMRP establishes a data route in an on-demand fashion using a control message for a route setup operation where data to be routed is present. If necessary, the above-described protocol can take action against frequent path variation of the mobile ad-hoc network by establishing the data route. That is, a method for determining a route in the mobile ad-hoc network has a mechanism to which a service search function is added to a routing algorithm appropriate for a distributed environment.

The development of a protocol that considers the properties of the mobile ad-hoc network is ongoing by the IETF (Internet Engineering Task Force) MANET (Mobile Ad-hoc NETwork) working group. Additionally, because a terminal of the mobile ad-hoc network has a limited battery capacity, etc., research on a routing method capable of efficiently consuming energy or power by considering the limited battery capacity is ongoing by the working group.

FIG. 1 illustrates a basic architecture of the mobile ad-hoc network. As illustrated in FIG. 1, a plurality of mobile hosts 110 to 190 communicate using a broadcast method. In FIG. 1, it is assumed that reference numeral 110 denotes a service request host desiring to receive service and reference numeral 190 denotes a destination host. In this case, the mobile hosts 120 to 180, other than the service request host 110 and the destination host 190, become relay hosts.

In order to set up a service route between the host 110 desiring to receive service in the mobile ad-hoc network and the destination host 190 in the mobile ad-hoc network, the service request host 110 generates and broadcasts a message including desired service information and destination information. The relay hosts 120 to 180 generate a relay message to transfer a service request message to the destination host 190, which will provide the service, and then broadcasts the generated message to the total mobile ad-hoc network 100.

The mobile ad-hoc network employs a routing method for determining a target host at the shortest distance by transferring the relay message from a neighbor host to a host next to the neighbor host. That is, the service route between the service request host 110 and the destination host 190 is determined and set up.

In order for the route to be set up, upon receiving the message from the service request host 110, the destination host 190 checks the service information recorded within the service request message. As a result of the checking, if the destination host 190 can provide the service, it generates a service response message to send the generated message to the corresponding service request host 110. However, if the destination host 190 cannot provide the service, the service request message is re-broadcast to the mobile ad-hoc network 100.

As indicated above, the mobile ad-hoc network provides the shortest route between a service requester and a service provider. That is, the mobile ad-hoc network calculates the number of hops required for a control message exchanged between the service requester and the service provider and sets a route having the smallest number of hops as a service route. However, the shortest route is determined without considering battery capacity, despite the fact that each of the terminals in the mobile ad-hoc network has a limited battery capacity. The service route can be cut off due to the battery consumption of a corresponding host, such that the established service route can be lost. As a result, all messages used for a current route setup operation for communication become unnecessary, and the service route must be re-set up for seamless communication. Accordingly, because a control message must be transferred so that a new route setup operation can be carried out, there is a problem in that a terminal or radio channel resource is unnecessarily consumed.

Further, there is another problem in that a control message overhead is incurred due to the flooding of control messages in the total network in which the mobile communication terminals determine a service route.

### SUMMARY OF THE INVENTION

Therefore, the present invention has been designed in view of the above and other problems, and it is an object of the present invention to provide a device and method for enabling a mobile communication terminal to determine a service route while considering the efficiency of energy in a mobile ad-hoc network.

It is another object of the present invention to provide a device and method that can reduce an overhead due to the flooding of service request control messages.

It is another object of the present invention to provide a device and method for efficiently employing a limited battery capacity of a mobile communication terminal in a mobile ad-hoc network.

It is yet another object of the present invention to provide a device and method for seamlessly maintaining a route for providing service in a mobile ad-hoc network.

In accordance with an aspect of the present invention, the above and other objects are accomplished by a mobile host for determining a route in a mobile ad-hoc network, comprising: a power information calculator for calculating power information using link transmission power for enabling the mobile host to transmit a message or data and remaining battery power; a message generator for generating a message for determining a host for a requested service and generating an SQPE (Service Query Power Extension) message including the power information calculated by the power information calculator; a radio module for converting the generated SQPE message into a radio signal and broadcasting the radio signal to the mobile ad-hoc network; and a controller for controlling an operation for generating the SQPE message, an operation for calculating the power information and the radio module.

In accordance with another aspect of the present invention, the above and other objects are accomplished by a method for determining a route in a mobile ad-hoc network including a plurality of mobile hosts, comprising: by a mobile host making a service request, broadcasting a service request message including service information, an address of the mobile host, a service destination address and power information; by one of relay hosts of the mobile hosts, selecting a service request message having largest power information from among service request messages received for a first time when the service request message is received, calculating power information of a mobile host, including the calculated power information of the mobile host in the power information included in the selected service request message and re-broadcasting the service request message; and by a destination host of the mobile hosts, selecting a service request message having largest power information from among service request messages received for a second time when the service request message is received, generating a service response message and transmitting the service response message along a route of the selected message.

### BRIEF DESCRIPTION OF THE DRAWINGS

The above and other objects, features, and advantages of the present invention will be more clearly understood from the following detailed description taken in conjunction with the accompanying drawings, in which:

FIG. 1 illustrates the basic architecture of a mobile ad-hoc network;

FIG. 2 is an internal block diagram illustrating mobile hosts in accordance with a preferred embodiment of the present invention;

FIG. 3 is a flow chart illustrating a control operation when a mobile host of the mobile ad-hoc network establishes a service route and serves as a relay host in accordance with the present invention;

FIG. 4 is a flow chart illustrating a control operation when a mobile host of the mobile ad-hoc network establishes a service route in accordance with the present invention; and

FIGS. 5A and 5B are flow charts illustrating a control operation when a mobile host of the mobile ad-hoc network serves as a relay host in accordance with the present invention.

### DETAILED DESCRIPTION OF THE PREFERRED EMBODIMENTS

Preferred embodiments of the present invention will be described in detail herein below with reference to the annexed drawings. In the following description, a detailed description of known functions and configurations incorporated herein will be omitted when it may make the subject matter of the present invention rather unclear. The words or expressions to be described below are defined on the basis of functions associated with the present invention. The defined words or expressions can be changed according to intentions or usual practices of a user or operator. Thus, the terminology can be based upon the entire contents of the present invention. Hereinafter, a mobile terminal is referred to as a mobile host. Accordingly, the “mobile host” in a mobile ad-hoc network means the mobile terminal. Moreover, the “host” in the mobile ad-hoc network is a mobile host.

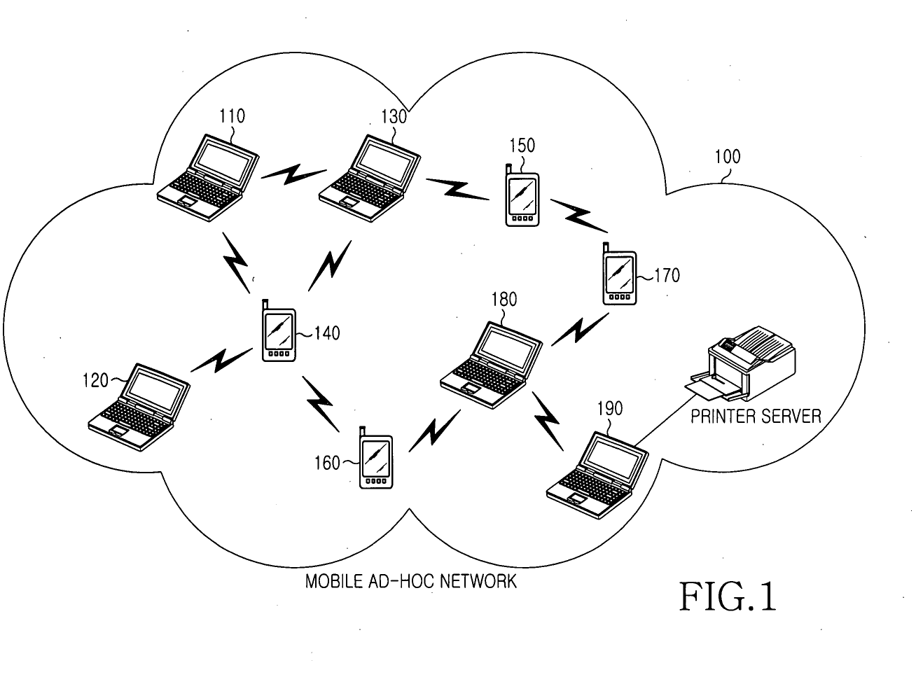

The architecture of the mobile ad-hoc network in accordance with the present invention is the same as illustrated in FIG. 1. That is, the mobile ad-hoc network in accordance with the present invention also comprises a service request host 110, relay hosts 120 to 180, and a destination host 190.

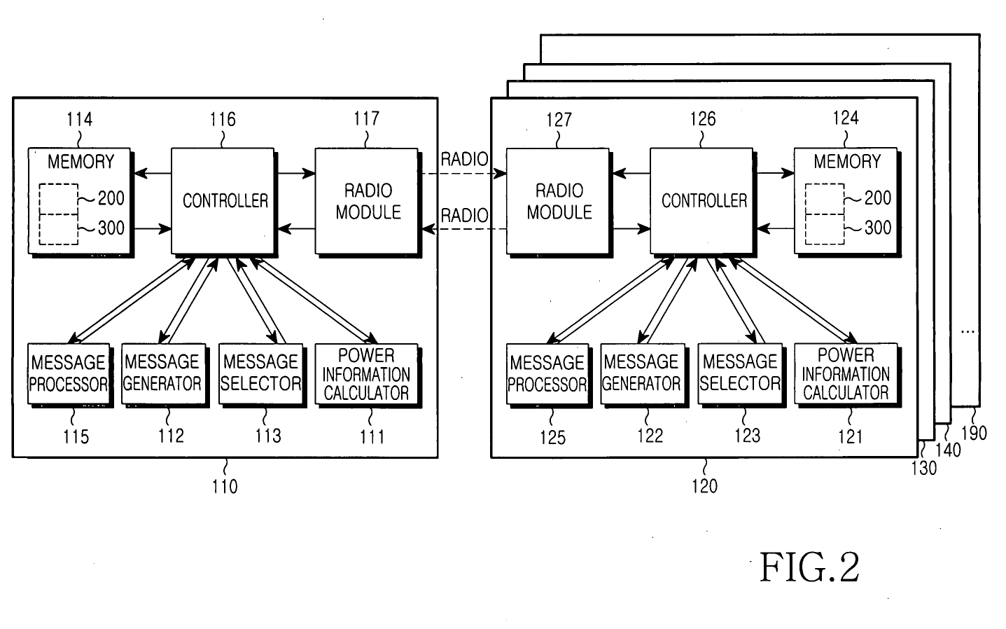

FIG. 2 is an internal block diagram illustrating mobile hosts in accordance 5 with a preferred embodiment of the present invention. More specifically, FIG. 2 illustrates an internal block diagram of the service request host 110 and an internal block diagram of the relay host 120. The service request host 110, the destination host 190 and the relay hosts 120 to 180 internally have the identical structure.

In the service request host 110, a power information calculator 111 calculates transmission power for a specific link coupled to the mobile host and battery power remaining in the mobile host. A resulting power value calculated by the power information calculator 111 is inversely proportional to a transmission power value for the specific link and is directly proportional to a remaining battery power value. All the mobile hosts 110 to 190 in accordance with the present invention store the calculated power value. The power information calculator provided in each of the mobile hosts 110 to 190 calculate power information as shown in Equation 1.

$${P}_{i} = ( \frac{{B}_{i}}{{L}_{i}} ) \qquad ( 1 )$$

In Equation 1, Pᵢ denotes a resulting power value calculated by the power information calculator of the i^{th} mobile host, Bᵢ denotes a remaining battery power value in the i^{th} mobile host, and Lᵢ denotes a transmission power value for the specific link in the i^{th} mobile host.

A message generator 112 generates messages required by the present invention. The first message in accordance with the present invention is an SQPE (Service Query Power Extension) message that is necessary for determining a host capable of providing service information desired by the service request host 110. The second message in accordance with the present invention is an SRPE (Service Reply Power Extension) message, which is generated in response to the SQPE message sent by the service request host 110. The SRPE message is generated by a host capable of providing service requested by the host sending the SQPE message.

The SQPE message is a message conventionally used for determining a service route. In accordance with the present invention, the SQPE message is a newly generated message in which power information is added to the conventional SQPE message. Accordingly, the SQPE message used for the present invention is different from the conventional SQPE message. Hereinafter, the SQPE message indicates only a message in accordance with the present invention. Fields included in the SQPE message in accordance with the present invention are shown in Table 1 below.

TABLE 1

| Sequence | SQPE message field |
|---|---|
| 1 | Address of host generating SQPE message |
| 2 | Address of host making service request |
| 3 | Service name |
| 4 | Address of service destination host |
| 5 | Serial number of SQPE message |
| 6 | Number of hops associated with SQPE message |
| 7 | Power information |

As shown in Table 1, the SQPE message includes a power information field in accordance with the present invention. The power information field includes a value based on the above Equation 1.

Fields included in the SRPE message in accordance with the present invention are shown in Table 2. The SRPE message used for the present invention is different from the conventional SRPE message. Hereinafter, the SRPE message indicates only a message in accordance with the present invention.

TABLE 2

| Sequence | SRPE message field |
|---|---|
| 1 | Address of host generating SRPE message |
| 2 | Address of host capable of providing service |
| 3 | Service name |
| 4 | Address of service destination host |
| 5 | Address of service request host |
| 6 | Distance between service request host and |
| | service destination host |
| 7 | Power information |

As shown in Table 2, the SRPE message includes a power information field in accordance with the present invention. The power information field includes a value based on the above Equation 1.

A message selector 113 selects a message having the largest power value from among SQPE messages received from a controller 116. The SQPE messages are received from neighboring hosts. That is, the SQPE messages are received through the controller 116 from the radio module 117. The controller 116 will be described in more detail below.

A memory 114 includes a route cache 200 and a service route table 300. The route cache 200 temporarily stores message information exchanged for service. Accordingly, the route cache 200 caches various information fields included in the received SQPE message. First, the route cache 200 caches requested service information. Second, the route cache 200 caches host information associated with the number of hops required for transferring the SQPE message. Third, the route cache 200 caches power information, etc. in accordance with the present invention. Accordingly, when the mobile host is a relay host, a route of the SRPE message sent by the host capable of providing service information using information stored in the route cache 200 can be determined. The information fields stored in the route cache 200 are shown in Table 3 below.

TABLE 3

| Sequence | Route cache field |
|---|---|
| 1 | Requested service information in SQPE message |
| 2 | Service destination host address in SQPE message |
| 3 | Address of previous host sending SQPE message |
| 4 | Power information in SQPE message |
| 5 | Time stamp in SQPE message |

As shown in the above Table 3, a message field stored in the route cache 200 includes power information in accordance with the present invention. Moreover, information necessary for determining a service route, and a time stamp value indicating a valid time of the message are stored in the route cache 200.

A case in which the service request host 110 is connected to the service destination host 190 and a service route is established so that a printer server connected to the service destination host 190 can print will be described with reference to FIG. 1. The service request host 110 generates an SQPE message for establishing the service route to the printer server and then broadcasts the generated SQPE message. When relaying the message shown in Table 1, the neighboring relay hosts 120 to 180 transmit the message to the destination host 190 while storing the message in the route cache 200 of the memory. Upon receiving the SQPE message, the destination host 190 generates and broadcasts an SRPE message shown in Table 2, such that the destination host 190 transfers a reply signal to the service request host 110. The mobile or relay host 180 nearest to the destination host 190 from among the relay hosts 120 to 180 stores a message as shown in Table 4 in the route cache 200.

TABLE 4

| Service | Service destination | Previous host (or | Power | Time |
|---|---|---|---|---|
| name | host address | relay host) address | information | stamp |
| Printer | 190 | 160 | P1 | T1 |
| Printer | 190 | 170 | P2 | T2 |

More specifically, messages received from other neighboring relay hosts 170 and 160 are stored as shown in Table 4.

The service route table 300 stored in the memory 114 stores information of mobile hosts coupled to a service route to store information of the service route established between the service request host 110 and the destination host 190. When the service request host 110 broadcasts an SQPE message, the service route table 300 stores information of relay hosts relaying the message. The service route table 300 stores requested service information, an address of a destination host and, information of mobile hosts corresponding to the next hops for transferring a message to the destination host for the requested service. Respective fields stored in the service route table 300 are shown in Table 5 below.

TABLE 5

| Sequence | Service route table field |
|---|---|
| 1 | Service name |
| 2 | Address of service request host |
| 3 | Address of destination host |
| 4 | Address of next relay host toward target host |
| | providing service |
| 5 | Lifetime of service route |

The service route table 300 stores information of all mobile hosts receiving the broadcast message for determining the service route. Exemplary information stored in the service route table 300 provided in the service request host 110 receiving the SRPE message from the destination host 190 for the printer service is shown in Table 6.

TABLE 6

| | Address of | | | |
|---|---|---|---|---|
| Service | service request | Destination | Address of | |
| name | host | address | next host | Lifetime of route |
| Printer | 110 | 190 | 130 | T1 |

When the mobile host 110 is a relay host, the message processor 115 receives an SQPE or SRPE message from a neighbor host and relays the received message. That is, when the SQPE or SRPE message is received through the controller 116 from the radio module 117, the relay operation is performed on the received message.

The controller 116 controls the power information calculator 111, the message selector 113, the message generator 112, and the message processor 115. Actually, the controller 116 can perform the functions of the power information calculator 111, the message selector 113, the message generator 112, and the message processor 115. The separate components in the present invention are merely provided to individually explain their respective functions. Accordingly, when a product is actually implemented, the controller 116 provided in the product is configured so that it can process all functions described above. Alternatively, the controller 116 can be configured so that it can process only part of the functions.

When transmitting/receiving a message or data between mobile hosts, the radio module 117 radio processes the transmitted/received message or data. That is, the radio module 117 up-converts the message or data to be transmitted into a corresponding frequency band and processes the up-converted message or data according to a predetermined transmission scheme and transmits a result of the processing. The radio module 117 processes a received message or data inversely to the transmission scheme and down-converts a result of the processing.

Referring to FIG. 1, to transfer SQPE and SRPE messages, the service request host 110 generates the SQPE message to make a service request and broadcasts the generated SQPE message to the total mobile ad-hoc network 100. The SQPE message includes power information in accordance with the present invention. Accordingly, the relay hosts 120 to 180 of the mobile ad-hoc network 100 receive the broadcast SQPE message and relay the received SQPE message to the destination host 190 through the neighbor hosts. The relay hosts 120 to 180 relay SQPE messages including their power information. Each of the relay hosts 120 to 180 determines whether the SQPE message has been repeatedly received. Moreover, each of the relay hosts 120 to 180 searches for the received SQPE message and determines whether it can provide service information.

If each of the relay hosts 120 to 180 determines that the SQPE message has not been repeatedly received and it can provide service information, a corresponding relay host generates and sends the SRPE message in response to the received SQPE message. That is, when storing information associated with the destination host 190 for the requested service although a corresponding host is a relay host, the corresponding host generates the SRPE message. However, before the destination host or the relay host storing the route information associated with the destination host generates the SRPE message, it waits to receive SQPE messages from other relay hosts for a predetermined time.

As described above, the host waits to receive SQPE messages in order to select a host with the largest power when the service route is established. As a result, the destination host or the relay host storing the route information associated with the destination host caches all SQPE messages received for the predetermined time in the route cache 200. Moreover, when the predetermined time elapses, the host selects an SQPE message having the largest power information from among a plurality of SQPE messages.

Subsequently, the destination host or the relay host storing the route information associated with the destination host stores information of a source host of the selected SQPE message, information of a previous host having relayed the SQPE message, and requested service information in its service route table 300. The destination host or the relay host storing the route information associated with the destination host generates the SRPE message in response to the SQPE message and transmits the generated SRPE message to the service request host 110 having generated the SQPE message. Because the SRPE message is transmitted through the established service route, no broadcast operation is employed. That is, the service route to the service request host 110 generating the SQPE message is established using information stored in the route cache 200 of each mobile host and then the SRPE message is transferred through the established service route. The power information included in the SRPE message is power information included in the SQPE message selected from among the plurality of SQPE messages. The relay hosts coupled to the service route for routing the SRPE message to the service request host 110 recognizes power information of the selected link.

The link power information can be recognized from the SQPE message received from the previous host. As described above, the i^{th} relay host updates according to Equation 2 when updating power information to be transmitted to the next host using the power information included in the SQPE message received from the previous host.

Pᵢ′=aPᵢ₋₁+(1−a)Pᵢ (2)

In Equation 2, “Pᵢ′” is power information updated in the i^{th} relay host, “a” is a weight value varying with a mobile velocity of a host, “Pᵢ₋₁” is power information included in the SQPE message received from the (i-1)^{th} host, and “Pᵢ” is power information of a mobile host receiving the SQPE message. “Pᵢ” is a value calculated using the Equation 1.

Where the host receiving the SQPE message is the destination host 190, the destination host 190 caches information of the SQPE messages received for the predetermined time in its own route cache 200. In this case, a host nearest to the destination host 190 is the service request host rather than the relay host. When the predetermined time expires, the destination host 190 selects the SQPE message having the largest power information value. Subsequently, the destination host 190 generates the SRPE message in response to the SQPE message, and transmits the generated SRPE message to the service request host 110 generating the SQPE message. The SRPE message includes a power information value included in the SQPE message selected by the destination host. Accordingly, power information of a link of the relay host coupled to the service route of the service request host can be recognized from the SRPE message.

The relay hosts receiving the SRPE message store service information included in the SRPE message in the service route table 300. More specifically, the relay router transmits the SRPE message to a previously selected relay host at the time of transferring the SQPE message, using stored route cache information. Similarly, other relay hosts transfer the SRPE message to their previous relay hosts, respectively.

If the service request host generating and transmitting the SQPE message receives the SRPE message through the above-described operation, its service route table 300 stores route information and power information based on the SRPE message. Accordingly, a service route between the service request host and the service destination host is established.

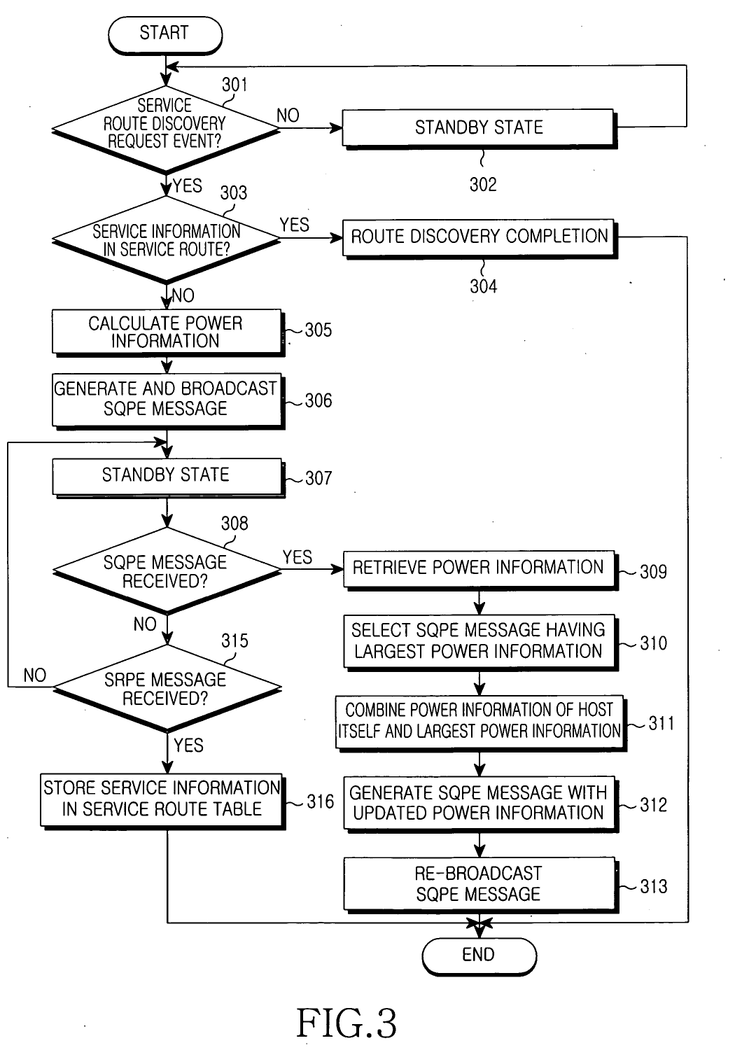

FIG. 3 is a flow chart illustrating a control operation when a mobile host of the mobile ad-hoc network establishes a service route and serves as a relay host in accordance with the present invention. In FIG. 3, it is assumed that the mobile host is the mobile host 110 illustrated in FIG. 1.

At step 301, the mobile host determines whether a service route discovery request event has been generated. If no service route discovery request event has been generated, the mobile host 110 continuously maintains the standby state at the above step 302. However, if the service route discovery request event has been generated, the mobile host 110 determines, at step 303, whether service route information associated with the service route discovery request event is stored in the service route table 300 of the mobile host 110. If the service route information is stored in the service route table 300, no route discovery operation toward another host is performed during a lifetime of corresponding route information at step 304. However, if no service information is stored in the user route table 300, the mobile host 110 performs a route discovery operation toward another host. That is, the mobile host 110 making a service request calculates power information using the Equation 1 at step 305. At step 306, the mobile host 110 generates and broadcasts an SQPE message for the route discovery operation in accordance with the present invention.

At step 307, the mobile host 110 maintains the standby state. The standby state at the above step 307 is the same as that step 302. That is, the standby state is a state waiting for specific event occurrence. Different positions indicating the standby states denoted by different reference numerals in FIG. 3 are for convenience of explanation.

While maintaining the standby state at step 307, the mobile host 110 determines, at step 308, whether an SQPE message has been received from another mobile host. That is, it is determined whether the mobile host 110 serves as a relay host. If the mobile host 110 has received no SQPE message from another mobile host, it proceeds to step 315. However, if the mobile host 110 has received the SQPE message, it proceeds to step 309.

At step 309, the mobile host 110 checks all power information fields included in all SQPE messages. At step 310, the mobile host 110 selects an SQPE message having the largest power information from among all the power information fields. At step 311, the mobile host 110 combines the power information included in the SQPE message selected at step 310 with its own power information calculated at step 305. At step 312, the mobile host 110 updates the SQPE message according to a result of the combining or generates an SQPE message having updated power information at step 311. “Updated Power Into” in FIG. 3 indicates the combined power information. Finally, at step 313, the mobile host 110 broadcasts the SQPE message having the updated power information.

However, at step 315, the mobile host 110 determines whether an SRPE message has been received from a specific host of the mobile ad-hoc network 100 in response to the SQPE message transmitted at 306. If no SRPE message has been received, the mobile host 110 maintains the standby state at step 307.

However, if an SRPE message has been received from a specific host of the mobile ad-hoc network 100 in response to the SQPE message, the mobile host 110 stores service route information of the SRPE message in the service route table at step 316. Subsequently, the mobile host 110 no longer performs the route discovery operation as long as the route information for a corresponding service is not discarded, and employs the service route information stored at step 316.

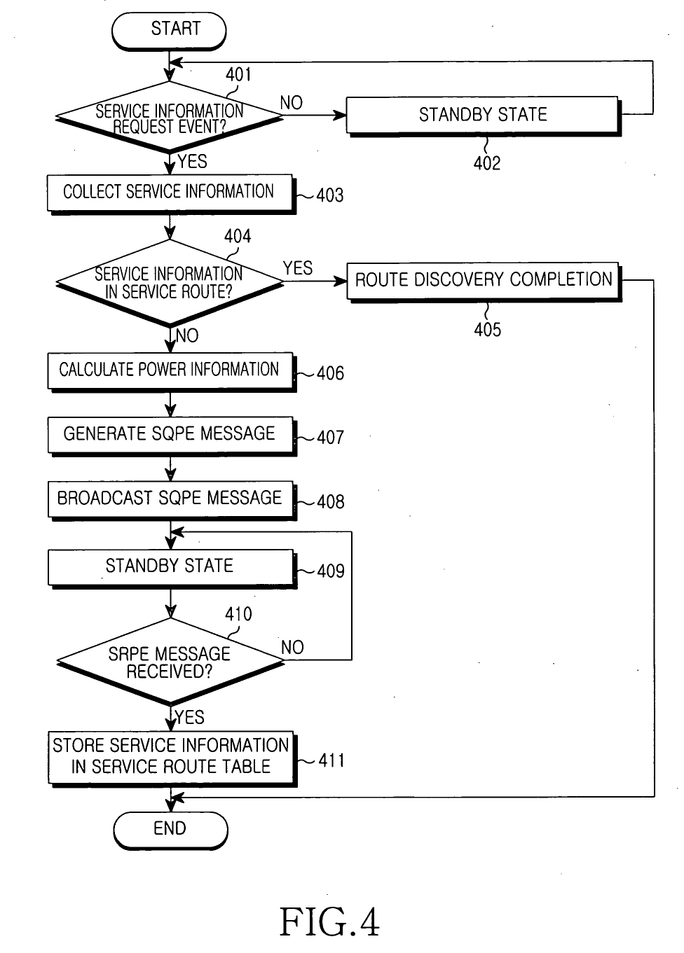

FIG. 4 is a flow chart illustrating a control operation when a mobile host of the mobile ad-hoc network establishes a service route in accordance with the present invention. In FIG. 4, it is assumed that the mobile host is the mobile host 110 illustrated in FIG. 2. The control flow chart illustrated in FIG. 4 will be described together with an internal structure of the mobile host 110.

Referring to FIG. 4, at step 401, the controller 116 of the mobile host 110 determines whether a service request event has been generated from a user. The service request event generated from the user is a user request generated according to a need while a specific program is executed. A user interface is not illustrated in FIG. 2. The controller 116 continuously maintains a standby state at step 402, if no service route request event has been generated. However, if the service route request event has been generated from the user, the controller 116 collects desired service information such as a service name, a service host address, etc., at step 403. That is, the controller 116 collects address information of a mobile host capable of providing a user-requested service and a service name such as user-requested printer service.

At step 404, the controller 116 determines whether the service route information of the user-requested service is stored in the service route table 300 of the memory 114. If corresponding service information is stored in the service route table 300 and the service route is valid, the controller 116 proceeds to step 405. The valid service route means that a lifetime of the service route has not expired. The controller 116 completes the service route discovery operation at step 405. That is, since the controller 116 recognizes the route information of a corresponding service, a service route discovery operation is not additionally performed while a lifetime of service route information remains.

However, if desired service information is not stored in the service route table 300, the controller 116 proceeds to step 406 and controls an operation of calculating power information of the mobile host 110 according to Equation 1. Here, a result value of the power information calculation operation is inversely proportional to power for a transmission operation to a link and is directly proportional to remaining battery power. The power information calculation is performed by the power information calculator 111 under control of the controller 116.

At step 407, the controller 116 generates an SQPE message for determining a host for providing desired service information. That is, the controller 116 controls the message generator 112 to generate the SQPE message. At step 408, the controller 116 controls the radio module 117 so that the SQPE message generated at step 407 can be broadcast to hosts belonging to the mobile ad-hoc network 100. At step 409, the controller 116 maintains the standby state. Here, the standby state at step 402 is the same as that at step 409. Different positions indicating the standby states denoted by different reference numerals are for convenience of explanation.

While the standby state is maintained at step 409, the controller 116 of the mobile host 110 determines, at step 410, whether an SRPE message has been received from one of the specific hosts 120 to 190 of the mobile ad-hoc network 100, in response to the SQPE message generated by the mobile host 110. The controller 116 determines whether the SRPE message received through the radio module 117 is a message responding to the SQPE message generated by the mobile host 110. If no SRPE message responding to the SQPE message has been received, the controller 116 continuously maintains the standby state at the above step 409. However, if an SRPE message has been received as a response signal corresponding to the SQPE message, the controller 116 proceeds to step 411, where it stores service information included in the SRPE message in the service route table 300 of the memory 114. Thus, the service request host 110 generating the SQPE message receives the SRPE message as the response. Subsequently, the service request host 110 stores information of the SRPE message in its service route table 300. Consequently, a service route is established between the service request host 110 and the destination host 190.

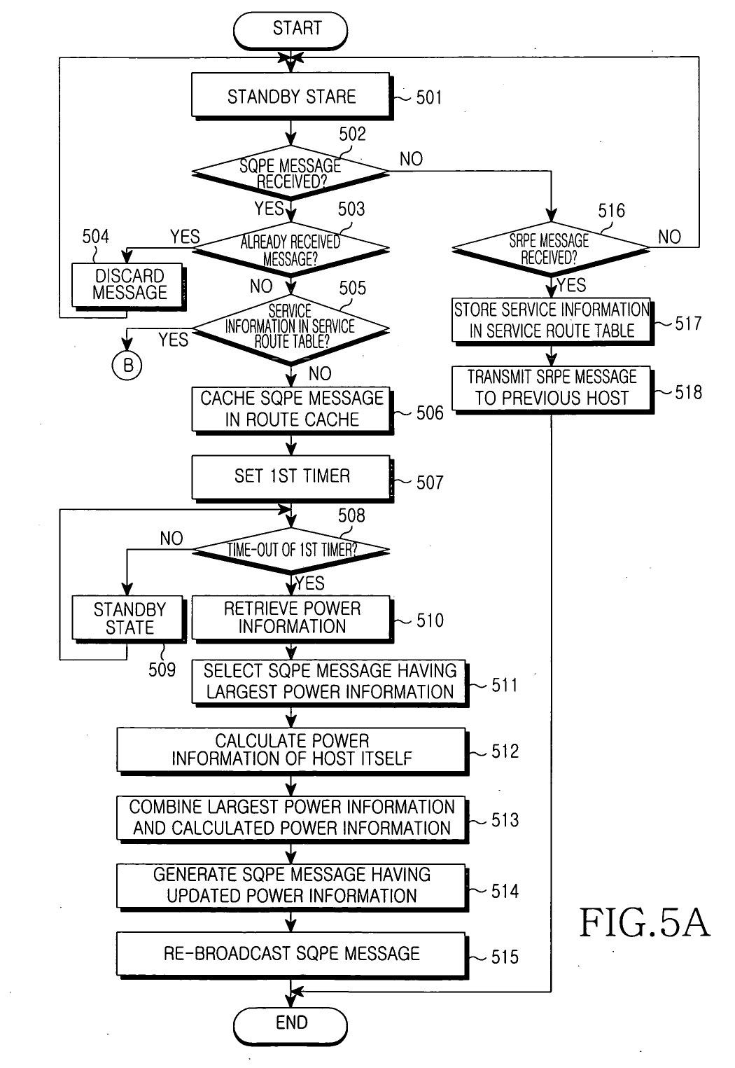

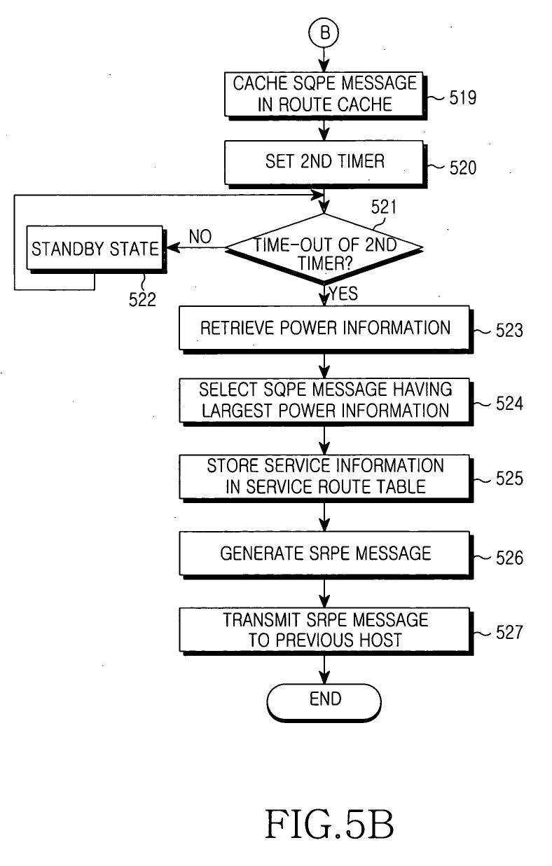

FIGS. SA and 5B are flow charts illustrating a control operation when a mobile host of the mobile ad-hoc network serves as a relay host in accordance with the present invention. The control flow in accordance with another embodiment of the present invention will be described with reference to FIGS. 5A and 5B. That is, FIGS. 5A and 5B show a control process in which a relay host processes an SQPE message as a service request message and an SRPE message as a service response message. In FIGS. 5A and 5B, it is assumed that a mobile host is the mobile host 170 of FIG. 1, and an interior structure of the mobile host 170 is illustrated by the reference numeral 120 of FIG. 2.

The control flow charts illustrated in FIGS. 5A and 5B will be described together with the internal structure of the mobile host 170.

The controller 126 of the mobile host 170 maintains a standby state at step 501. Here, the standby state is limited to a state waiting for receiving an SQPE message for a route setup operation or an SRPE message responding to the SQPE message. Moreover, it is assumed that the mobile host 170 is not the mobile host generating the SQPE message.

The controller 126 of the mobile host 170 maintains the standby state at the above step 501, and determines, at step 502, whether the SQPE message for a service route setup request has been received from another mobile host from the radio module 127. If the SQPE message has been received from the radio module 127, the controller 126 determines whether the received SQPE message has already been received at step 503. When the controller 126 determines whether the SQPE message has been repeatedly received, it uses information of the route cache 200 of the memory 124 temporarily storing the SQPE message.

When the received SQPE message has already been cached in the route cache 200, the controller 126 discards the received SQPE message at step 504. That is, when the identical message is received from the same mobile host at least two times, the controller 126 discards the received message using the route cache 200. However, if the received SQPE message has not been cached in the route cache 200, the controller 126 determines, at step 505, whether requested service information based on the received SQPE message can be provided. Moreover, the controller 126 determines whether service route information based on the SQPE message is present in the service route table 300 of the memory 124.

If the requested service information based on the received SQPE message is not present in the service route table 300, the controller 126 performs step 506. However, if the request service information is present in the service route table 300, the controller 126 performs step 519. The above step 519 will be described with reference to FIG. 5B.

At step 506, the controller 126 stores information included in the received SQPE message in the route cache 200 of the memory 124. The information cached in the route cache 200 includes requested service information based on the received SQPE message, information of a previous host sending the SQPE message, power information, etc. This information is used for determining a service route for routing the SRPE message as a response to the SQPE message.

At step 507, the controller 126 presets a time t1 in a first timer. The time t1 preset in the first timer is the time required for receiving other SQPE messages in addition to the received SQPE message and establishing the most efficient route using the received SQPE messages.

At step 508, the controller 126 determines whether a signal indicating a time-out of the first timer has been received. If no signal has been received, the controller 126 proceeds to step 509 for another SQPE message processing state. Here, another SQPE message processing state means a state in which an SQPE message for the same service request associated with the same destination host and the same service request host is received from another mobile host and the received message is cached in the route cache for the time preset in the first timer. The SQPE message is received from another mobile host so that the mobile ad-hoc network is used and the message is broadcast. As described above, the SQPE message is received and stored for the time preset in the first timer. Only when an identical message is received at least two times, is the message discarded.

If a signal indicating the time-out of the first timer has been received, the controller 126 retrieves power information included in the SQPE message received for the time of the first timer from the route cache 200 at step 510. After retrieving the route cache 200 provided in the memory 124, the controller 126 selects the SQPE message having the largest power information from the route cache 200 at step 511.

At step 512, the controller 126 controls the power information calculator 121 to calculate power information of the mobile host 120. The power information of the mobile host 120 can be calculated according to Equation 1. At step 513, the controller 126 combines battery power information of the mobile host 120, transmission power information of a link for transmitting a message or data, and power information of the SQPE message selected at step 511, thereby producing updated power information. The updated power information is produced using the above Equation 2. At step 514, the controller 126 updates the SQPE message using the power information updated at the above step 513 at step 515, the controller 126 re-broadcasts the SQPE message including the updated power information to the mobile ad-hoc network 100.

At step 516, it is determined whether an SRPE message has been received from another neighbor mobile host. If no SRPE message has been received, the controller 126 maintains the standby state at step 501. However, if an SRPE message has been received, the controller 126 stores service information in the service route table 300 provided in the memory 124 at step 517. In other words, the controller 126 extracts the service information included in the SRPE message, information of a previous mobile host sending the SRPE message, service route information, etc., and stores the extracted information in the service route table 300. Subsequently, the controller 126 searches for the previous mobile host and then sends the SRPE message to the searched previous mobile host at step 518. The previous mobile host can be identified using the information cached in the route cache 200 at step 506.

Referring to FIG. 5B, if the service information based on the SQPE message is present in the service route table 300 as the result of the determination at step 505 in FIG. 5A, the controller 126 caches the received SQPE message in the route cache at step 519. When the route information based on the SQPE message is present in a mobile host, the operation of the mobile host is the same as that of the destination host. The information cached in the route cache 200 includes requested service information based on the received SQPE message, information of a previous host sending the SQPE message, power information, etc., in accordance with the present invention.

At step 520, after performing the above step 519, the controller 126 presets a time t2 in a second timer. The time t2 is preset in the second timer so that SQPE messages are received from other mobile hosts in addition to the received SQPE message and the most efficient route can be discovered using the received SQPE messages.

After setting the second timer, at step 521, the controller 126 determines whether a signal indicating a time-out of the second timer has been received. If no signal indicating a time-out of the second timer has been received, the controller 126 maintains the standby state at step 522. However, if a signal indicating the time-out of the second timer has been received at the above step 521, the controller 126 proceeds to step 523. Here, the standby state at step 522 is a state waiting for receiving SQPE messages from other mobile hosts. Accordingly, when a different SQPE message is received, the received SQPE message is cached in the route cache 200.

Subsequently, when the second timer expires, the controller 126 proceeds to step 523. The controller 126 checks the SQPE message having the largest power information among the SQPE messages at step 523 and selects the SQPE message having the largest power information at step 524.

At step 521,, the controller 126 stores information included in the SQPE message selected at step 524 in the service route table 300 of the memory 124. At step 526, the controller 126 controls the message generator 122 to generate an SRPE message. The SRPE message generated by the message generator 122 is a response message to the SQPE message selected at step 524. That is, the SRPE message is generated as shown in Table 2. Power information included in the SRPE message is produced from the power information included in the SQPE message selected at step 524, power information of the mobile host 170, and power information of a previous mobile host. Accordingly, link power information of the relay hosts coupled to the service route associated with the service request host can be recognized from the SRPE message.

At step 527, the controller 126 controls the radio module 127 to transmit the generated SRPE message. The SRPE message is transferred to the service request host having sent the SQPE message using the information cached in the route cache 200 at step 518. That is, when at least one relay host is present between the mobile host 170 and the service request host, the SRPE message is transferred through the at least one relay host. If the relay host has received the SQPE message from the service request host for the first time, it directly relays the SRPE message to the service request host.

Upon receiving the SRPE message from the relay host, the service request host sending the SQPE message can confirm the service route. That is, the service request host stores the service route information included in the received SRPE message in its service route table 300, such that a corresponding service route can be established.

As is apparent from the above description, the present invention provides a number of advantageous effects. More specifically, the present invention provides a device and method for enabling a mobile communication terminal to determine a service route while considering the efficiency of energy in a mobile ad-hoc network, thereby seamlessly providing service information without cutting off a service route for providing the service information due to power consumption of the mobile communication terminal.

Further, the present invention provides a device and method for considering remaining battery power for link transmission, selecting a message necessary for determining an optimum service route, and broadcasting the selected message, thereby preventing the flooding of unnecessary messages in a mobile ad-hoc network.

Although the preferred embodiments of the present invention have been disclosed for illustrative purposes, those skilled in the art will appreciate that various modifications, additions and substitutions are possible, without departing from the scope of the present invention. Therefore, the present invention is not limited to the above-described embodiments, but the present invention is defined by the following claims, along with their full scope of equivalents.

What is claimed is:

1. A mobile host for determining a route in a mobile ad-hoc network, comprising:
a power information calculator for calculating power information using link transmission power, which will enable the mobile host to transmit data, and remaining battery power;
a message generator for generating a message for determining a host for a requested service and generating an SQPE (Service Query Power Extension) message including the power information calculated by the power information calculator; and
a radio module for converting the generated SQPE message into a radio signal and broadcasting the radio signal to the mobile ad-hoc network.

2. The mobile host according to claim 1, further comprising:
a controller for controlling the power information calculator, the message generator, and the radio module.

3. The mobile host according to claim 1, further comprising:
a route cache for caching SQPE messages received from other mobile hosts; and
a message selector for selecting an SQPE message having a largest power information from among the SQPE messages received from the other mobile hosts,
wherein the power information calculator generates new power information in the SQPE message using power information of its mobile host and power information included in the SQPE message having the largest power information; and
wherein the message generator and the radio module re-broadcast the SQPE message based on the information calculated by the power information calculator.

4. The mobile host according to claim 3, further comprising:
a service route table for storing information of a service route, wherein the service route table is checked when the SQPE message is received, and the message generator generates an SRPE (Service Reply Power Extension) message when requested route information is present and the service route is valid.

5. The mobile host according to claim 4, wherein the SRPE message comprises:
an address of a host generating the SRPE message;
an address of a host capable of providing service;
a service name;
an address of a service request host;
an address of a service destination host;
a distance between the service request host and the service destination host; and
power information.

6. The mobile host according to claim 1, wherein the SQPE message comprises:
an address of a host generating the SQPE message;
an address of a service request host;
a service name;
an address of a service destination host; and
power information.

7. A method for determining a route for enabling a mobile host to receive a requested service in a mobile ad-hoc network, comprising:
collecting information of the requested service and determining whether route information of the requested service is present in a previously provided service route table, when the service is requested;
calculating power information of the mobile host, generating an SQPE (Service Query Power Extension) message including the calculated power information, and broadcasting the generated SQPE message, when the route information of the requested service is not present in the service route table; and
establishing a service route based on the route information included in an SRPE (Service Reply Power Extension) message, when the SRPE message is received as a response message to the SQPE message.

8. The method according to claim 7, further comprising:
storing the route information included in the SRPE message in the service route table.

9. The method according to claim 7, further comprising:
receiving another SQPE message from another mobile host, after the SQPE message is transmitted from the mobile host;
including the calculated power information in the received SQPE message; and
re-broadcasting the SQPE message including the calculated power information.

10. The method according to claim 7, wherein the SQPE message comprises:
an address of a host generating the SQPE message;
an address of a service request host;
a service name;
an address of a service destination host; and
power information.

11. The method according to claim 7, further comprising:
receiving another SQPE message from another mobile host, after the SQPE message is transmitted from the mobile host;
determining whether requested destination route information based on the SQPE message from the another mobile host is present in the service route table;
generating an SRPE message based on the requested destination route information, when the requested destination route information is present;
including the power information of the mobile host and power information of the service route in the SRPE message; and
transmitting the SRPE message to the another mobile host having generated the SQPE message.

12. The method according to claim 11, wherein the SRPE message is generated only if the service route is valid when the service route information is present in the service route table.

13. The method according to claim 11, wherein the SRPE message comprises:
an address of a host generating the SRPE message;
an address of a host capable of providing service;
a service name;
an address of a service request host;
an address of a service destination host;
a distance between the service request host and the service destination host; and
power information.

14. A method for enabling a mobile host to receive and relay a service request message for route discovery in a mobile ad-hoc network, comprising:
receiving the service request message;
determining whether requested destination route information based on the service request message is present in a service route table;
generating a service response message using the requested destination route information, when the requested destination route information is present;
including power information of the mobile host and power information of a service route in the service response message; and
transmitting the service response message to a mobile host sending the service request message.

15. The method according to claim 14, further comprising:
when the service request message is firstly received, waiting for receiving messages indicating information associated with another mobile host and a destination host for a preset time, the received messages being associated with the service request as in the service request message;
selecting a message having a largest power information from among the received messages associated with the service request; and
generating the service response message according to a result of the selection.

16. The method according to claim 14, further comprising:
including the power information of the mobile host in the service request message and re-broadcasting the service request message, when the requested destination information based on the service request message is not present in the service route table.

17. A method for determining a route in a mobile ad-hoc network including a plurality of mobile hosts, comprising:
broadcasting, from a requesting mobile host of the plurality of mobile hosts, a service request message including service information, an address of the requesting mobile host, a service destination address, and power information;
selecting, by at least one relay mobile host of the plurality of mobile hosts, a service request message having a largest power information from among service request messages received for a first time when the service request message is received, calculating power information of the at least one relay mobile host, including the calculated power information of the at least one relay mobile host in the power information included in the selected service request message, and re-broadcasting the service request message; and
selecting, by a destination mobile host of the plurality of mobile hosts, a service request message having a largest power information from among service request messages received for a second time when the service request message is received, generating a service response message, and transmitting the service response message along a route of the selected message.

18. The method according to claim 17, wherein the power information calculated in each of the mobile hosts is produced using link power information at a time of providing service and remaining battery power information.

19. The method according to claim 17, wherein power information of the service request message updated by the at least one relay mobile host is an update value considering power information of a previous relay host, and mobility and power information of the at least one relay mobile relay host.

20. The method according to claim 17, further comprising:
checking, by each of the at least one relay hosts, a service route table, when the service request message is received;
generating the service response message when requested route information based on the service request message is present in the service route table; and
transmitting the service response message to the requesting mobile host.

21. The method according to claim 20, wherein each of the at least one relay hosts generates the service response message only if the route is valid when the route information based on the service request message is present in the service route table.
